(19) United States
(12) Patent Application Publication
(10) Pub. No.: US 2015/0161000 A1
(43) Pub. Date: Jun. 11, 2015

(54) NONVOLATILE MEMORY DEVICE, DISTRIBUTED DISK CONTROLLER, AND DEDUPLICATION METHOD THEREOF

(71) Applicant: Samsung Electronics Co., Ltd., Suwon-Si (KR)

(72) Inventors: Ji Hong KIM, Seoul (KR); Tae Jin KIM, Suwon-si (KR); Ji Sung PARK, Seoul (KR); Sung Jin LEE, Seoul (KR)

(73) Assignee: SNU R&DB Foundation, Seoul (KR)

(21) Appl. No.: 14/565,107

(22) Filed: Dec. 9, 2014

(30) Foreign Application Priority Data
Dec. 10, 2013 (KR) 10-2013-0153199

(51) Int. Cl. G06F 11/10; G06F 3/06

(52) U.S. Cl. CPC G06F 11/108; G06F 3/0679; G06F 3/0619; G06F 3/0655; G06F 3/0641; G06F 3/0608; G06F 2206/1014

(57) ABSTRACT

Provided are a nonvolatile memory device and a deduplication method thereof. The nonvolatile memory device includes a plurality of data storages written in a unit of data block; and a storage controller dividing write-requested data in a unit of data block to generate a plurality of data blocks, determining whether each of predetermined data blocks from among the plurality of data blocks is duplicated, generating parity data with reference to non-duplicated data blocks from among the predetermined data blocks, and controlling the plurality of data storages such that the parity data and the non-duplicated data blocks are written into at least one of the plurality of data storages. Since a deduplication operation is performed before generating parity data to assure reliability of data, the number of write operations is reduced and restoration probability of the nonvolatile memory device increases.

### CROSS-REFERENCE TO RELATED APPLICATIONS

This US non-provisional patent application claims priority under 35 USC §119 to Korean Patent Application No. 10-2013-0153199, filed on Dec. 10, 2013, the entirety of which is hereby incorporated by reference.

### BACKGROUND

1. Technical Field

Example embodiments relate to nonvolatile memory devices and deduplication methods thereof. At least some example embodiments are directed to a distributed disk (e.g., a RAID) system based nonvolatile memory device to dispersively store data in a plurality of data storages and a deduplication method thereof.

2. Discussion of Related Art

The information age has produced an explosive increase in the demand for personal data storage. With this increasing demand, various types of personal data storage devices have been developed.

For example, hard disk drives (HDDs) have been widely used due to various attractive features such as high recording density, high speed of data transmission, fast data access time, and low cost.

In recent years, solid-state disks or drives (SSDs) have been developed to replace HDDs. An SSD is a data storage device that uses a solid-state semiconductor memory as a main form of data storage. Unlike HDDs, SSDs do not include a platter and related mechanical parts. As a result, SSDs tend to have lower mechanical driving time and latency, and faster read/write times as compared with HDDs. As a result, SSDs tend to have fewer errors due to latency and mechanical friction compared with HDDs, so their reliability in performing read/write operations tends to be better than that of HDDs. Moreover, SSDs generate relatively little heat and noise during operation, and they can withstand physical shock, which makes them increasingly attractive.

### SUMMARY

Example embodiments relate to a nonvolatile memory device and a deduplication method thereof.

In some example embodiments the nonvolatile memory device receives data including a plurality of data storage units from a host. The nonvolatile memory device may include a plurality of data storages configured to store the plurality of data storage units; and a storage controller configured to control the plurality of data storages such that a first non-duplicated data storage unit from among the plurality of data storage units and first parity data generated with reference to the first non-duplicated data storage unit are stored in at least one of the plurality of data storages.

In some example embodiments, the storage controller may determine whether each of the plurality of data storage units is duplicated before the first parity data is generated.

In some example embodiments, the storage controller may determine whether each of the plurality of data storage units is duplicated by using a hash value calculated for the plurality of data storage units.

In some example embodiments, the storage controller may select predetermined data storage units from among the plurality of data storage units, and to control the plurality of data storages such that a second non-duplicated data storage unit from among the predetermined data storage units and second parity data generated with reference to the second non-duplicated data storage unit are stored in the plurality of data storages.

In some example embodiments, the storage controller may control the plurality of data storages by using a redundant array of inexpensive disk (RAID) system.

Some example embodiments relate to a nonvolatile memory device receiving write-requested data from a host.

In some example embodiments, the nonvolatile memory device may include a plurality of data storages written in a unit of data block; and a storage controller dividing the write-requested data in the unit of data block to generate a plurality of data blocks, determining whether each of predetermined data blocks from among the plurality of data blocks is duplicated, generating parity data with reference to non-duplicated data blocks from among the predetermined data blocks, and controlling the plurality of data storages such that the parity data and the non-duplicated data blocks are written into at least one of the plurality of data storages.

In some example embodiments, the storage controller may not generate the parity data when all of the predetermined data blocks are duplicated.

In some example embodiments, the storage controller may map a logical block address of duplicated data blocks from among the predetermined data blocks with a physical block address of a previously written data blocks having same data as the duplicated data blocks.

In some example embodiments, the storage controller may include a fingerprint generating unit calculating a hash value of each of the predetermined data blocks; and a deduplication table storing a hash value and a physical block address of each data block stored in the plurality of data storages. The storage controller may determine a data block, from among the predetermined data blocks, having a same hash value as the hash value stored in the deduplication table to be a duplicated data block.

In some example embodiments, the storage controller may further include a main memory to which a deduplication manager and the deduplication table are loaded; and a processing unit controlling the main memory such that the deduplication manager divides the write-requested data in a unit of block to generate the plurality of data blocks and determine whether each of the predetermined data blocks from among the plurality of data blocks is duplicated.

In some example embodiments, a parity generator may be further loaded to the main memory, and the processing unit may control the main memory such that the parity generator generates the parity data with reference to the non-duplicated data blocks from among the predetermined data blocks.

In some example embodiments, a predefined memory capacity may be allocated to the deduplication table, and the deduplication manager may replace an entry stored in the deduplication table when a capacity for the deduplication table exceeds the predefined memory capacity.

In some example embodiments, the deduplication manager may replace the entry stored in the deduplication table by using a first-in-first-out (FIFO) algorithm.

Some example embodiments relate to a deduplication method of a nonvolatile memory device including a plurality of data storages controlled by using a redundant array of inexpensive disk (RAID) system.

In some example embodiments, the deduplication method may include generating first parity data with reference to first non-duplicated data storage units from among write-requested data received from a host; and storing the first parity data and the first non-duplicated data storage units in at least one of the plurality of data storages.

In some example embodiments, the generating first parity data may include dividing the write-requested data into data storage units having predefined size; determining whether each of predetermined data storage units from among the data storage units is duplicated; and generating second parity data with reference to second non-duplicated data storage units from among the predetermined data storage units.

In some example embodiments, the predefined size may be determined according to a write unit of the plurality of data storages.

In some example embodiments, the whether each of predetermined data storage units from among the data storage units is duplicated may include calculating a hash value of each of the predetermined data storage units; and determining a data storage unit, from among the predetermined data storage units, having a same hash value as a hash value of each data storage unit stored in the plurality of data storages to be a duplicated data storage unit.

In some example embodiments, the deduplication method may further include mapping a logical block address of duplicated data storage units from among the predetermined data storage units with a physical block address of a previously stored data storage unit having same data as the duplicated data storage units.

Some example embodiments relate to a distributive disk controller.

In some example embodiments, the distributive disk includes a processor configured to, associate write data received from a host with different storage devices such that the write data is distributed among the storage devices in units of data blocks; identify if the data blocks of write data received from the host are duplicative of a data block of stored data stored in the storage devices; and for each data block identified as non-duplicative write data with respect to the stored data, generate parity data associated with the non-duplicative write data based on the non-duplicative write data, and store the non-duplicative write data and the parity data in the plurality of storage devices such that the non-duplicative write data is stored based on the association.

In some example embodiments, if the write data is duplicative write data with respect to the stored data, the processor is configured to map a logical block address associated with the duplicative write data with a physical block address associated with the stored data which is duplicative thereof.

In some example embodiments, the processor is configured to identify if the write data is duplicative of the stored data before generating the parity data associated therewith, and for each data block identified as duplicative of the stored data, the processor is configured to not generate corresponding parity data.

In some example embodiments, the processor is configured to, distribute the write data in units of data blocks among the storage devices based on a RAID-5 distribution scheme, and generate the parity data by performing an Exclusive OR (XOR) operation on the non-duplicative write data.

In some example embodiments, the processor is configured to not generate parity data associated with a stripe, if the controller identifies all of the write data associated with the stripe as duplicative write data, the stripe being a set of the write data that can be distributed by the distributive disk among the storage devices.

In some example embodiments, the processor is configured to identify if the write data is duplicative of the stored data by, calculating a hash value associated with the data blocks; and identifying one of the data blocks of write data as duplicative, if the hash value associated with the data block is same as a hash value associated with a data block of the stored data.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain principles of the disclosure. In the drawings:

FIG. 1 is a block diagram of a nonvolatile memory device connected to a host;

FIG. 2 illustrates a data storing operation of the nonvolatile memory device in FIG. 1;

FIG. 3 illustrates a deduplication operation of the nonvolatile memory device in FIG. 1;

FIG. 4 is a block diagram of a nonvolatile memory device according to an embodiment and a host connected to the nonvolatile memory device;

FIG. 5 is a block diagram illustrating an embodiment of a storage controller in FIG. 4;

FIG. 6 illustrates a data storing method of the nonvolatile memory device in FIG. 4;

FIG. 7 illustrates a parity data generating operation of the storage controller in FIG. 5;

FIG. 8 is a graph making a comparison between the amount of data write of the nonvolatile memory device in FIG. 1 and that of the nonvolatile memory device in FIG. 4;

FIG. 9 is a flowchart illustrating a deduplication method of a nonvolatile memory device according to some example embodiments;

FIG. 10 is a block diagram illustrating an example in which a nonvolatile memory device according to some example embodiments is applied to a solid state drive (SSD) system;

FIG. 11 is a block diagram illustrating an example in which a nonvolatile memory device according to some example embodiments is applied to a memory card; and

FIG. 12 is an example diagram illustrating various systems to which the memory card in FIG. 11 is applied.

### DETAILED DESCRIPTION

The advantages and features of the example embodiments and methods of achieving them will be apparent from the example embodiments that will be described in more detail with reference to the accompanying drawings. It should be noted, however, that the example embodiments are not limited to the following example embodiments, and may be implemented in various forms. Accordingly, the example embodiments are provided only to disclose examples and to let those skilled in the art understand the nature of the example embodiments.

Detailed illustrative embodiments are disclosed herein. However, specific structural and functional details disclosed herein are merely representative for purposes of describing example embodiments. Example embodiments may be embodied in many alternate forms and should not be construed as limited to only those set forth herein.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

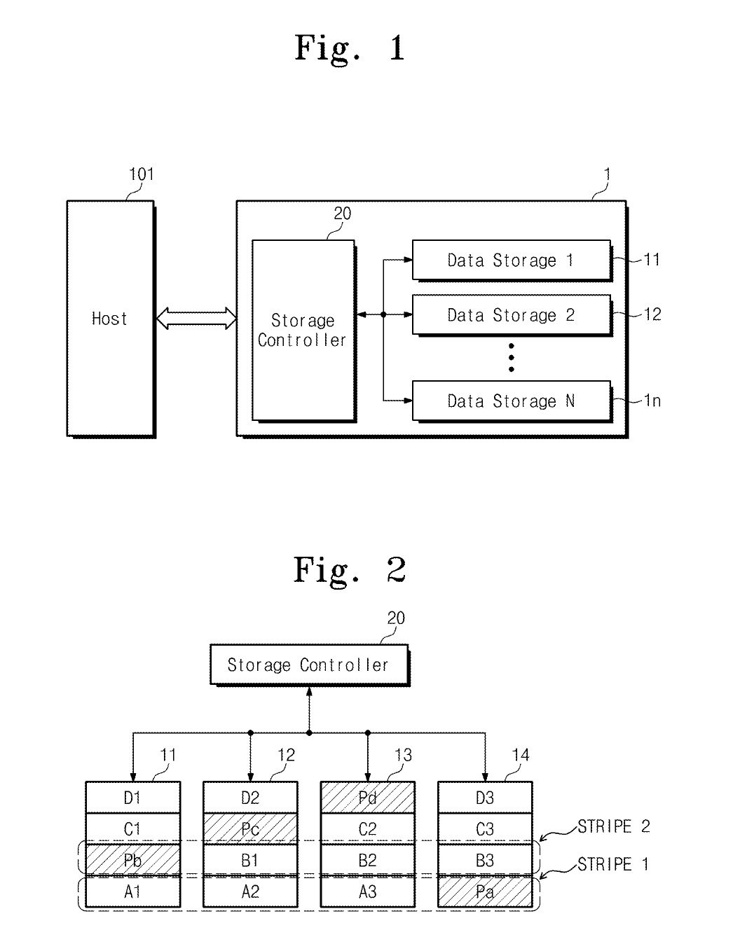

FIG. 1 is a block diagram of a nonvolatile memory device 1 connected to a host 101.

Referring to FIG. 1, the host 101 may control the nonvolatile memory device 1. The host 101 may be a portable electronic device such as a portable multimedia player (PMP), a personal digital assistant (PDA), and a smart phone or an electronic device such as a computer and a high-definition television (HDTV).

The nonvolatile memory device 1 stores data in response to control of the host 101. The data stored in the nonvolatile memory device 1 is retained even when a power supply of the nonvolatile memory device 1 is interrupted. The nonvolatile memory device 1 includes a storage controller 20 and a plurality of data storages 11 to 1n.

The data storages 11 to 1n store data provided from the host 101 in response to control of the storage controller 20. The data storages 11 to 1n may be, for example, solid-state drives (SSDs), however example embodiments are not limited thereto.

The storage controller 20 controls a data processing operation on the data storages 11 to 1n in response to a command provided from the host 101. The storage controller 20 may control the data storages 11 to 1n such that the host 101 recognizes the data storages 11 to 1n as a single storage or a plurality of storages.

The storage controller 20 may control a data processing operation on the data storages 11 to 1n by using a distributed disk system. For example, a Redundant Array of Inexpensive (or, alternatively, Independent) Disk (RAID) system. In some example embodiments, the storage controller 20 may control a data processing operation on the data storages 11 to 1n by using a RAID level-5 system to enhance reliability of the stored data.

The storage controller 20 may divide the data provided from the host into fixed-sized data units by using the RAID level-5 system and may dispersively store the divided data units in the data storages 11 to 1n constituting a single logical storage according to a Round-Robin algorithm. That is, the storage controller 20 may interleave the divided data units with the data storages 11 to 1n. A set of data that is interleaved by the storage controller 20 and can be inputted/outputted concurrently is defined as a stripe such that the storage controller 20 may store the data provided from the host 101 in a unit of stripe.

A RAID 5 system may include block-level striping with distributed parity, such that parity information is distributed among the data storages 11 to 1n. Upon failure of a single data storage 11 to 1n, subsequent reads can be calculated from the distributed parity such that no data is lost.

When a single stripe is stored in N data storages, the storage controller 20 may store data transferred from the host 101 in (N-1) data storages and store parity data for the data stored in the (N-1) data storages in a single data storage by using the RAID level-5 system. Since the storage controller 20 controls the data storages 11 to 1n to dispersively store data in parallel, the storage controller 20 has improved data processing speed. In addition, since the storage controller 20 may restore damaged data by using parity data even when one of data storages storing a single stripe is damaged, reliability of data stored in a data storage may be enhanced.

Each of the data storages 11 to 1n may perform a deduplication operation on data inputted from the host 101. The deduplication operation is an operation to refer to previously stored data instead of storing inputted data in data storages when the inputted data is identical to the previously stored data. For example, the nonvolatile memory device 10 may map a physical block address for the previously stored data with a logical block address for the data inputted from the host 101 without storing the inputted data when the data inputted from the host 101 is identical to the previously stored data.

FIG. 2 illustrates a data storing operation of the nonvolatile memory device 10 in FIG. 1.

As illustrated in FIG. 2, the nonvolatile memory device 1 includes four data storages 11 to 14, however, example embodiments are not limited thereto.

The storage controller 20 divides data A into fixed-sized data storage units A1 to A3 when the data A is provided from the host 101 (see FIG. 1). In some example embodiments, a data storage unit may be a block, however, example embodiments are not limited thereto. For example, the data storage unit may be a page, a page group including a plurality of pages, a file, a sector, and a cluster including a plurality of sectors.

The storage controller 20 generates parity data Pa for the divided data storage units A1 to A3. The data storage units A1 to A3 and the parity data Pa constitute a first stripe STRIPE 1. The storage controller 20 dispersively stores the data storage units A1 to A3 and the parity data Pa in the data storages 11 to 14, respectively.

Similarly, the storage controller 20 divides data B into fixed-sized data storage units B1 to B3 when the data B is provided from the host 101. The storage controller 20 generates parity data Pb for the divided data storage units B1 to B3. The data storage units B1 to B3 and the parity data Pb constitute a second stripe STRIPE 2. The storage controller 20 dispersively stores the data storage units B1 to B3 and the parity data Pb in the data storages 11 to 14, respectively.

The storage controller 20 may store the parity data Pa and Pb for the first and second stripes STRIPE 1 and STRIPE 2, which are successive stripes, in different data storages. For example, if the parity data Pa for the first stripe STRIPE 1 is stored in a fourth data storage 14, the parity data Pb for the second stripe STRIPE 2 may be stored in a first data storage 11. The storage controller 20 may distribute data storages which parity data of each stripe is stored in to increase probability of data restoration.

FIG. 3 illustrates a deduplication operation of the nonvolatile memory device 10 in FIG. 1.

As illustrated in FIG. 3, the nonvolatile memory device 1 includes four data storages 11 to 14, however, example embodiments are not limited thereto.

The storage controller 20 divides data A into fixed-sized data storage units A1 to A3 when the data A is provided from the host 101 (see FIG. 1).

As described with reference to FIG. 2, a data storage unit may be a data block.

The storage controller 20 generates parity data Pa for the divided data storage units A1 to A3. The data storage units A1 to A3 and the parity data Pa constitute a first stripe STRIPE 1. The storage controller 20 dispersively stores the data storage units A1 to A3 and the parity data Pa in the data storages 11 to 14, respectively.

Similarly, the storage controller 20 divides data B into fixed-sized data storage units B1 to B3 when the data B is provided from the host 101. The storage controller 20 generates parity data Pb for the divided data storage units B1 to B3. The data storage units B1 to B3 and the parity data Pb constitute a second stripe STRIPE 2. The storage controller 20 dispersively stores the data storage units B1 to B3 and the parity data Pb in the data storages 11 to 14, respectively.

Each of the data storages 11 to 14 performs a deduplication operation on store-requested data. The deduplication operation may be performed with reference to data stored in all of the data storages 11 to 14.

For example, when a data storage unit B1 is identical to a previously stored data storage unit A1, the data storage unit B1 is not physically stored in a second data storage 12. When reading of the data B is requested, the second data storage 12 provides the data storage unit B1 with reference to the data storage unit A1 stored in the first data storage 11.

However, since the storage controller 20 may be unable to access the data storage unit A1 when the first data storage 11 is damaged, the second data storage 12 may be unable to locate the data for the data storage unit B1. Therefore, the storage controller 20 may perform data restoration by using parity data to restore the damaged data.

However, the rest of the data storing units B2 and B3 associated with the data B and the parity data Pb for the data B may be required to restore the data storage unit B1. However, as illustrated in FIG. 3, the parity data Pb is stored in the first data storage 11, which is damaged. Since the first data storage 11 is damaged, the storage controller 20 may be unable to read out the parity data Pb. Therefore, the data B may not be restored even when a single data storage is damaged, thus, hindering the benefit of RAID.

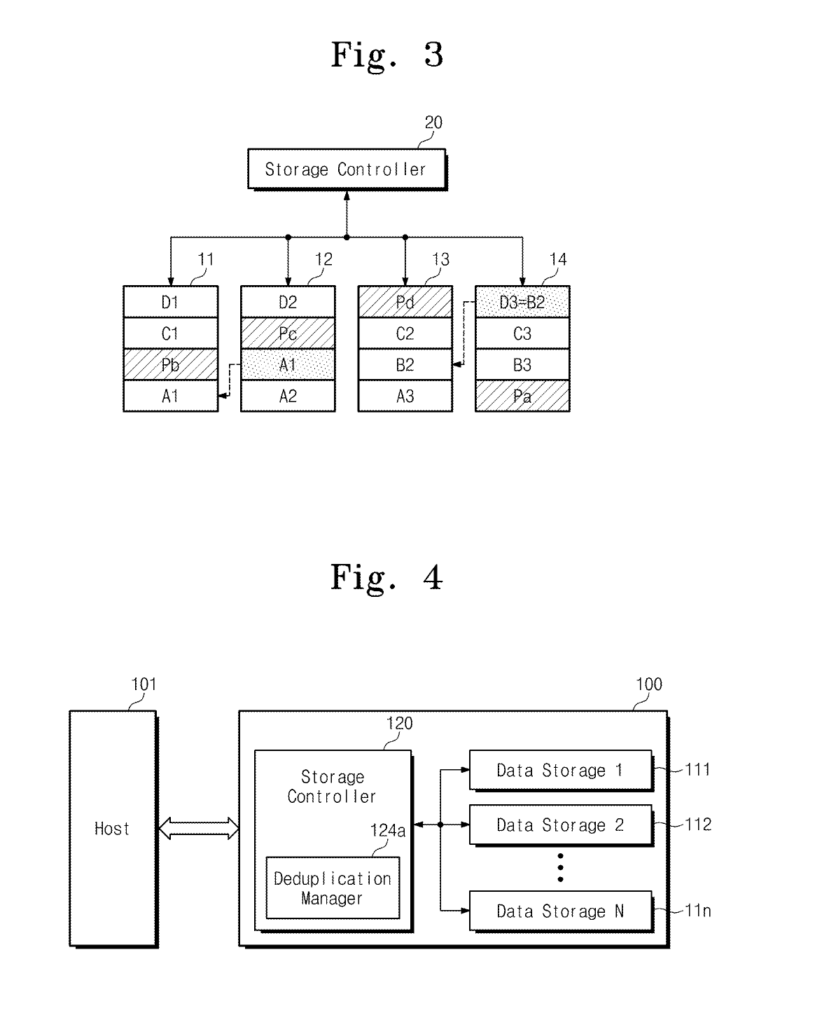

FIG. 4 is a block diagram of a nonvolatile memory device 100 according to some example embodiments and a host 101 connected to the nonvolatile memory device 100.

Referring to FIG. 4, the host 101 may control the nonvolatile memory device 100. The host 101 may be a portable electronic device such as a portable multimedia player (PMP), a personal digital assistant (PDA), and a smart phone or an electronic device such as a computer and a high-definition television (HDTV).

The nonvolatile memory device 100 stores data in response to control of the host 101. The data stored in the nonvolatile memory device 100 is retained even when a power supply of the nonvolatile memory device 100 is interrupted. The nonvolatile memory device 100 includes a storage controller 120 and a plurality of data storages 111 to 11n.

The nonvolatile memory device 100 performs a deduplication operation first before generating parity data. The storage controller 120 of the nonvolatile memory device 100 generates parity data with reference to only data to be physically stored during an operation of generating parity data for a stripe. Therefore, the number of write operations for the parity data is reduced and restoration probability of the nonvolatile memory device 100 increases when one of the data storage 111 to 11n is damaged.

The storage controller 120 controls a data processing operation on the data storages 111 to 11n in response to a command provided from the host 101. The storage controller 120 may control the storages 111 to 11n such that the data storages 111 to 11n are recognized as a single storage or a plurality of data storages.

The storage controller 120 may control a data processing operation on the data storages 111 to 11n by using a RAID system. In particular, the storage controller 120 may control a data processing operation on the data storages 111 to 11n by using a RAID level-5 system to enhance reliability of the data stored in the storage controller 20.

The storage controller 120 may divide the data provided from the host 101 into fixed-sized data units by using the RAID level-5 system and may dispersively store the divided data units in the data storages 111 to 11n constituting a single logical storage according to a Round-Robin algorithm. That is, the storage controller 20 may store the data provided from the host 101 in a unit of stripe.

The storage controller 120 includes a deduplication manager 124a to perform a deduplication operation on data inputted from the host 101.

By using the deduplication manager 124, the storage controller 120 may divide data provided from the host 101 into fixed-sized data storage units and perform a deduplication operation on each of the data storage units. For example, when a write-requested data storage unit is identical to previously stored data, the storage controller 120 may map a physical block address for the previously stored data with a logical address (e.g., logic block address) for a data storage unit without storing the write-requested data storage unit.

The storage controller 120 may generate parity data for each stripe after performing a deduplication operation. The storage controller 120 refers to only data determined to be non-duplicated data when generating the parity data. By referring to only non-duplicated data when generating the parity data, the storage controller 120 may increase the probability of restoring a damaged data storage unit using the parity data.

For example, when the data storage units A1 to A3 and their parity data constitute a single stripe and the data storage unit A2 is determined to be duplicated data, the storage controller 120 generates parity data for the data storage units A1 to A3 with reference to only the data storage units A1 and A3. When data storage 11 storing the data storage unit A1 therein is damaged, the storage controller 120 may restore the data storage unit A1 by using only the data storage unit A3 and parity data.

When all of the data storage units A1 to A3 are duplicated data, the storage controller 120 may not generate parity data. Since the storage controller 120 does not generate and store parity data when data is not physically stored, the number of unnecessary calculation and unnecessary write operation for parity data may be reduced.

The above-described nonvolatile memory device 100 performs a deduplication operation first before generating parity data. The storage controller 120 of the nonvolatile memory device 100 generates parity data with reference to only data to be physically stored during an operation of generating parity data for a stripe. Since the nonvolatile memory device 100 generates parity data with reference to only data determined to be non-duplicated data in the stripe, the number of write operations for the parity data is reduced and restoration probability of the nonvolatile memory device 100 increases when a data storage is damaged.

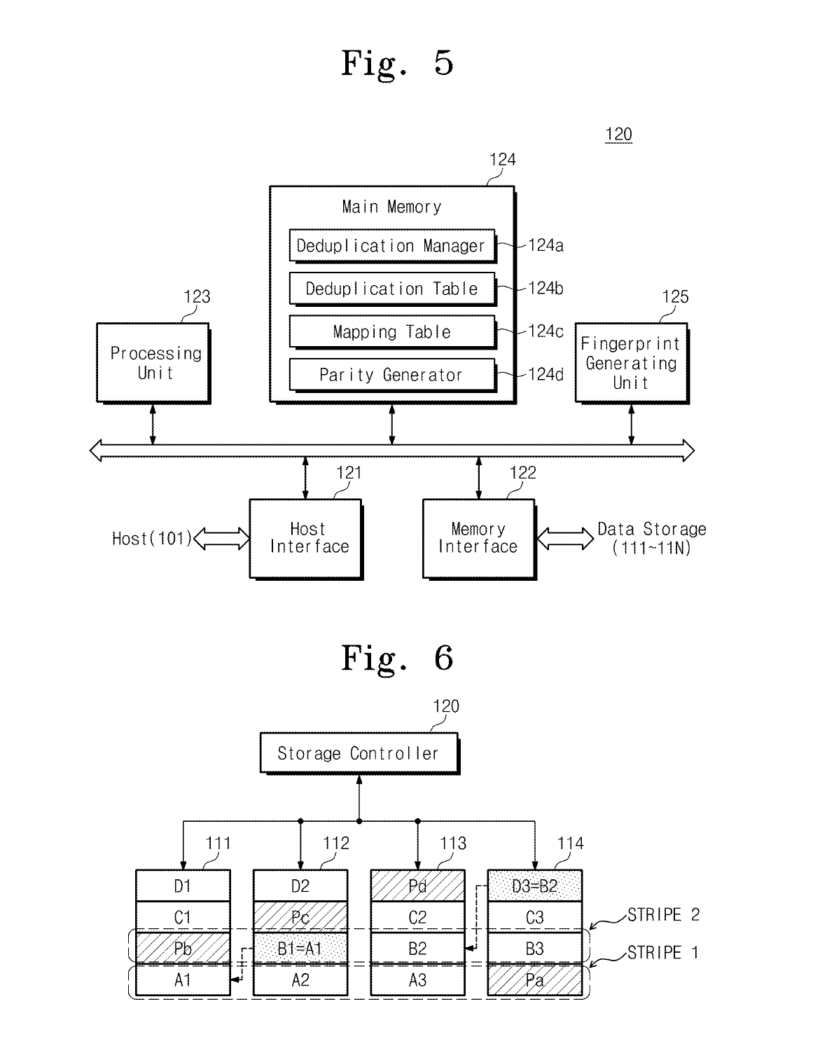

FIG. 5 is a block diagram illustrating the storage controller 120 in FIG. 4 according to some example embodiments.

As illustrated in FIG. 5, the storage controller 120 may include a host interface 121, a memory interface 122, a processing unit 123, a main memory 124, and a fingerprint generating unit 125.

The storage controller 120 generates parity data with reference to only data to be physically stored during an operation of generating parity data for a stripe. Since a nonvolatile memory device 100 including the storage controller 120 generates parity data with reference to only data determined to be non-duplicated data in the stripe, the number of write operations for the parity data is reduced and restoration probability of the nonvolatile memory device 100 increases when a data storage is damaged.

The host interface 121 provides an interface between the host 101 (see FIG. 1) and the storage controller 120. The host 101 and the storage controller 120 may exchange data via one or more of various standardized interfaces.

The storage controller 120 may exchange data with the host 101 via one of various interface protocols. The standardized interfaces include various interface manners such as an ATA (advanced technology attachment) interface, a SATA (serial ATA) interface, an e-SATA (external SATA) interface, a SCSI (small computer small interface) interface, a SAS (serial attached SCSI) interface, a PCI (peripheral component interconnection) interface, a PCI-E (PCI express) interface, an USB (universal serial bus) interface, an IEEE 1394 interface, and a card interface.

The memory interface 122 provides an interface between a plurality of data storages 111 to 11n (see FIG. 1) and the storage controller 120. For example, data processed by the processing unit 123 may be stored in a plurality of data storages 111 to 11n (see FIG. 1) via the memory interface 122. Likewise, data stored in the plurality of data storages 111 to 11n (see FIG. 1) may be provided to the processing unit 123 via the memory interface 122.

The processing unit 123 controls the overall operation of the storage controller 120. The processing unit 123 may include a central processing unit (CPU) or a micro-processing unit (MPU). The processing unit 123 may drive firmware to control the storage controller 120. The firmware may be loaded to the main memory 124 to be driven.

The main memory 124 stores data and firmware to control the storage controller 120. The firmware and the data stored in the main memory 124 may be driven by the processing unit 123. The main memory 124 may store meta data or cache data. The main memory 124 may include various types of memories such as a cache memory, a DRAM, an SRAM, and a PRAM.

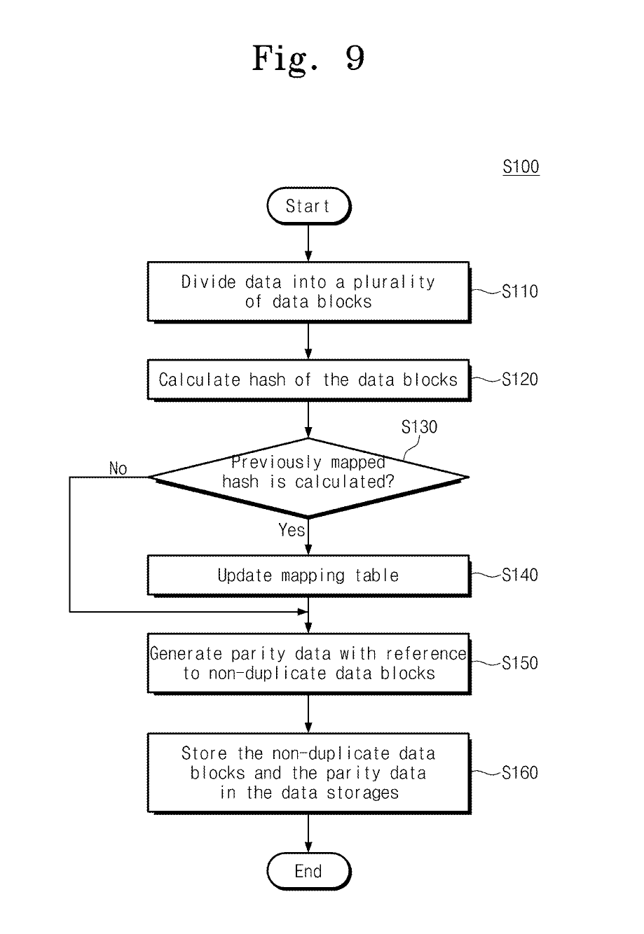

The processing unit 123 may be an arithmetic logic unit, a digital signal processor, a microcomputer, a field programmable array, a programmable logic unit, a microprocessor or any other device capable of responding to and executing instructions in a defined manner such that the processor is programmed with instructions that configure the processing device as a special purpose computer to perform the operations illustrated in FIG. 9, such that the processing unit 123 performs a deduplication operation, and, thereafter, generates and stores parity data. Moreover, the processing unit 123 may be programmed with instructions to recover damaged data using the stored parity data.

The instructions executed by the processor may be stored on a non-transitory computer readable medium. Examples of non-transitory computer-readable medium include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable medium may also be a distributed network, so that the program instructions are stored and executed in a distributed fashion.

As illustrated in FIG. 5, the main memory 124 of the controller 120 may have loaded therein a deduplication manager 124a, a deduplication table 124b, a mapping table 124c, and a parity generator 124d. The processing unit 123 may load the deduplication manager 124a, the deduplication table 124b, the mapping table 124c, and the parity generator 124d from the data storages 111 to 11n in the main memory 124.

The deduplication manager 124a performs a deduplication operation on data input from the host 101.

When write-requested data A is provided from the host 101, the deduplication manager 124a divides the write-requested data A into a plurality of data storage units A1 to A3. In some example embodiments, a data storage unit may be a block. The deduplication manager 124a receives hash values for the data storage units A1 to A3 from the fingerprint generator 125.

For each of the data storage units A1 to A3, the fingerprint generator 125 generates hash values that may represent the respective data storage units A1 to A3. The fingerprint generator 125 may use various hash functions to generate hash values. Although the fingerprint generator 125 may be implemented in hardware to improve performance, example embodiments are not limited thereto. For example, the fingerprint generator 125 may be implemented in software loaded to the main memory 124 of the controller 120.

The deduplication manager 124a compares the hash values generated for the data storage units A1 to A3 with hash values of previously stored data, with reference to a deduplication table 124b. The deduplication table 124b is a table to store hash values and physical addresses (e.g., physical block addresses) of the data stored in the data storages 111 to 11n.

The deduplication table 124b may be a table having a fixed size. The deduplication table 124b may store hash values and physical block addresses of all of the data stored in the data storages 111 to 11n. When memory capacity allocated to the deduplication table 124b becomes insufficient, the deduplication table 124b may write over a stored entry. For example, the deduplication table 124b may replace an entry by using a first-in-first-out (FIFO) algorithm.

When the same hash value is found, the deduplication manager 124a determines a data storage unit to be duplicated data and does not store the data storage unit in the data storage units 111 to 11n. Instead, the deduplication manager 124a updates a mapping table 124c to map a logical address for the data storage unit with a physical address of a physical storage unit having the same hash value as the data storage unit. The mapping table 124c is a table to store mapping information of a logical address and a physical address (e.g., a logic block address and a physical block address) of the data stored in the data storages 111 to 11n.

The deduplication manager 124a may perform the above-described deduplication operation on all of logical address spaces. However, when capacity of the main memory 124 is insufficient, the deduplication manager 124a may selectively perform a deduplication operation only on data included in a portion of a logical address space.

The parity generator 124d generates parity data with reference to data storage units determined to be non-duplicated data, from among data storage units constituting a single stripe. Only the data storage units determined to be non-duplicated data and their parity data are stored in the data storages 111 to 11n.

The above-described storage controller 120 generates parity data with reference to only data to be physically stored during an operation of generating parity data for a stripe. Since the nonvolatile memory device 100 including the storage controller 120 generates parity data with reference to only data determined to be non-duplicated data in the stripe, the number of write operations for the parity data is reduced and restoration probability of the nonvolatile memory device 100 increases when a data storage is damaged.

FIG. 6 illustrates a data storing method of the nonvolatile memory device 100 in FIG. 4.

As illustrated in FIG. 6, the nonvolatile memory device 100 includes four data storages 111 to 114, however, example embodiments are not limited thereto.

The storage controller 120 divides data A into data storage units A1 to A3 (e.g., fixed-sized storage units A1 to A3) when the data A is provided from the host 101 (see FIG. 4).

The storage controller 120 calculates hash values for the divided data storage units A1 to A3. The storage controller 120 performs a deduplication operation on each of the data storage units A1 to A3 by using the calculated hash values and the deduplication table 124b (see FIG. 5).

When the deduplication operation is completed, the storage controller 120 generates parity data Pa for data A. The data storage units A1 to A3 and the parity data Pa constitute a first stripe STRIPE 1. The storage controller 120 dispersively stores the data storage units A1 to A3 and the parity data Pa in the data storages 111 to 114, respectively.

Similarly, the storage controller 120 divides data B into fixed-sized data storage units B1 to B3 when the data B is provided from the host 101.

The storage controller 120 calculates hash values for the divided data storage units B1 to B3. The storage controller 120 performs a deduplication operation on each of the data storage units B1 to B3 by using the calculated hash values and the deduplication table 124b.

For example, when a hash value of the data storage unit B1 is equal to that of the data storage unit A1, the storage controller 120 maps a physical address of a physical storage unit storing the data storage unit A1 therein with a logical address of the data storage unit B1.

When the deduplication operation is completed, the storage controller 120 generates parity data Pb for the data B. The storage controller 120 generates parity data with reference to data storage units determined to be non-duplicated data from among data storage units constituting a single stripe. That is, the storage controller 120 generates the parity data Pb with reference to only the data storage units B2 and B3.

The data storage units B1 to B3 and the parity data Pb constitute a second stripe STRIPE 2. The storage controller 120 dispersively stores the parity data Pb and data storage units B2 and B3 determined to be non-duplicated data in the data storages 111, 113, and 114, respectively.

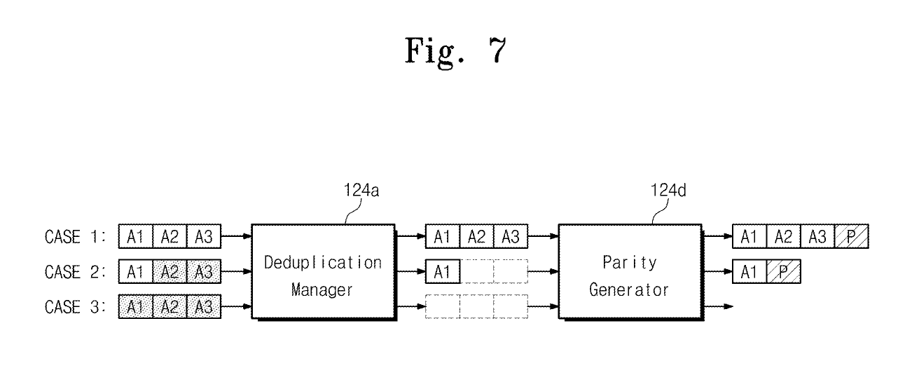

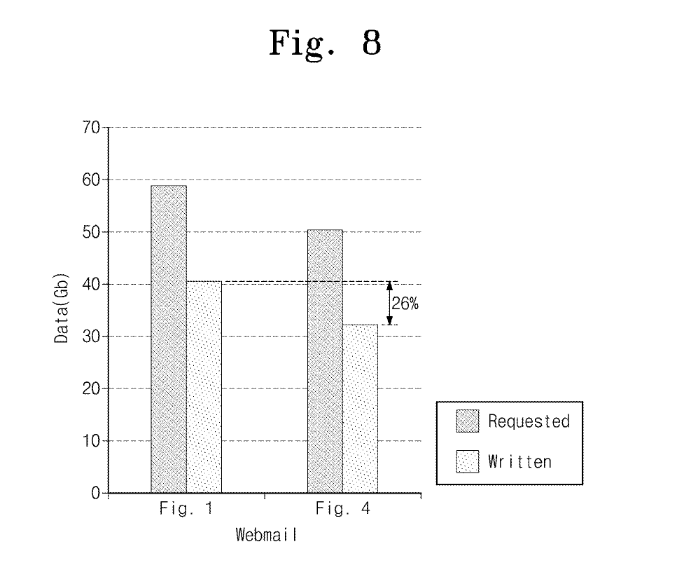

FIG. 7 illustrates a parity data generating operation of the storage controller 120 in FIG. 5.

As illustrated in FIG. 7, three data storage units 1 to 3 and a single parity data P may constitute a stripe, however, example embodiments are not limited thereto.

In CASE 1, all of three write-requested data storage units A1 to A3 are non-duplicated data. Therefore, the parity generator 124d generates parity data P with reference to all of the data storage units A1 to A3. The storage controller 120 stores the data storage units A1 to A3 and the parity data P in a plurality of data storages 111 to 11n (see FIG. 4) via the memory interface 122 (see FIG. 5).

In CASE 2, the data storage units A2 and A3, from among the three write-requested data storage units A1 to A3, are duplicated data. Therefore, the deduplication manager 124a determines that the data storage units A2 and A3 are duplicated data and maps a logical address for the data storage units A2 and A3 with a physical address for a physical storage unit storing the same data as the data storage units A2 and A3.

The parity generator 124d generates parity data P with reference to only the data storage unit A1 that is non-duplicated data, from among data storage units constituting a stripe. The data storage unit A1 and the parity data P are stored in the plurality of data storages 111 to 11n (see FIG. 4) via the memory interface 122 (see FIG. 5).

In CASE 3, all of three write-requested data storage units A1 to A3 are duplicated data. Therefore, the deduplication manager 124a determines the data storage units A1 to A3 are duplicated data and maps a logical address for the data storage units A1 to A3 with a physical address for a physical storage unit storing the same data as the data storage units A1 to A3.

When all of the write-requested data storage units A1 to A3 are duplicated data, the parity generator 124d does not generate parity data. The storage controller 120 does not perform a write operation on data storage units and parity data.

Since the nonvolatile memory device 100 including the above-described storage controller 120 generates parity data with reference to only data determined to be non-duplicated data in a stripe, the number of write operations for the parity data is reduced and restoration probability of the nonvolatile memory device 100 increases when a data storage is damaged.

FIG. 8 is a graph making a comparison between the amount of data write of the nonvolatile memory device in FIG. 1 and that of the nonvolatile memory device in FIG. 4.

Referring to FIG. 8, a horizontal axis denotes write-requested data and written data into data storages with respect to each of the nonvolatile memory device in FIGS. 1 and 4, and a vertical axis denotes the respective data amounts.

Due to at least the fact that the storage controller 120 generates parity data with reference to only data determined to be non-duplicated data, the amount of data written in the nonvolatile memory device in FIG. 4 is decreased as compared with that of the nonvolatile memory device in FIG. 1.

FIG. 9 is a flowchart illustrating a deduplication method of a nonvolatile memory device according to some example embodiments.

In operation S110, the storage controller 120 divides data inputted from the host 101 (see FIG. 4) into fixed-sized data storage units, e.g., data blocks. The storage controller 120 may determine the size of the data blocks according to a write unit of a plurality of data storages 111 to 11n (see FIG. 4).

In operation S120, the storage controller 120 may calculate hash values for the divided data blocks. The storage controller 120 may calculate the hash values using hardware or software by various hash functions.

In operation S130, the storage controller 120 may determine if a data block, from among data blocks stored in the data storages 111 to 11n, has the same hash value as the calculated hash value for the input data.

In operation S140, if there is a stored data block having the same hash value as the input data, the storage controller 120 maps a logical block address for a write-requested data block with a physical block address for a physical block storing the data block having the same hash value.

In operation S150, the storage controller 120 generates parity data with reference to only data blocks determined to be non-duplicated data, from among data blocks constituting a single stripe. For example, the storage controller 120 may generate the parity data by performing an Exclusive OR (XOR) operation on the data blocks determined to be non-duplicated. By generating the parity data using the XOR operation, the storage controller 120 may recover damaged data by performing a second XOR operation on the parity data and the non-damaged data to recover the damaged data.

In step S160, the storage controller 120 stores the data blocks determined to be non-duplicated data and the generated parity data in the data storages 111 to 11n.

According to the above-described deduplication method S100, since a nonvolatile memory device generates parity data with reference to only data determined to be non-duplicated data in a stripe, the number of write operations for the parity data is reduced and restoration probability of the nonvolatile memory device increases when a data storage is damaged.

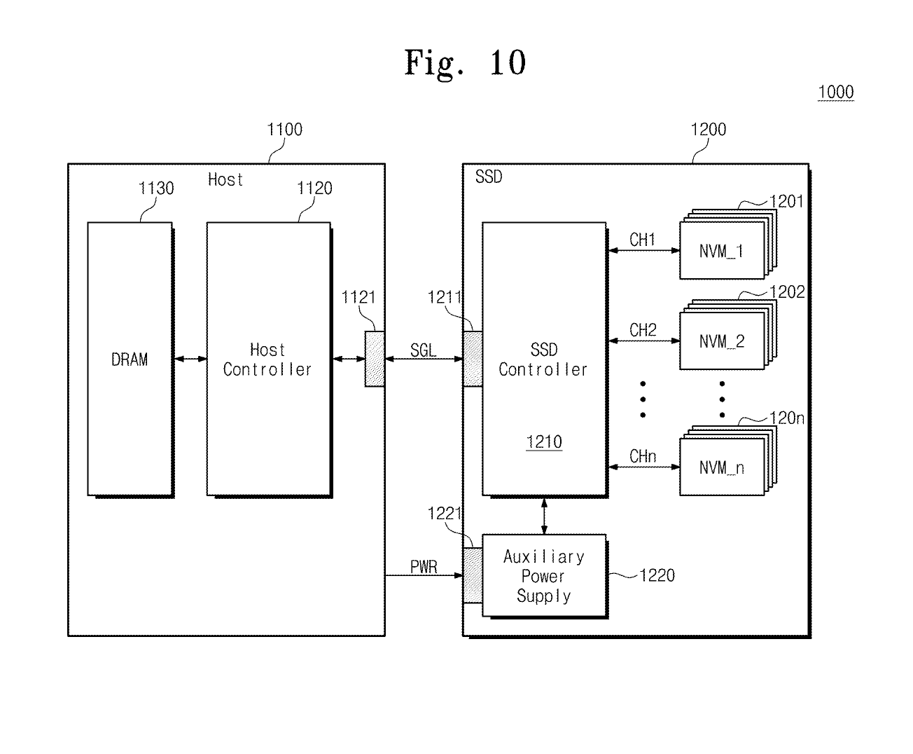

FIG. 10 is a block diagram illustrating an example in which a nonvolatile memory device according to some example embodiments is applied to a solid state drive (SSD) system 1000. As illustrated, the SSD system 1000 includes a host 1100 and an SSD 1200. The host 1100 includes a host interface 1121, a host controller 1120, and a DRAM 1130.

The host 1100 writes data into the SSD 1200 or reads data stored in the SSD 1200. The host controller 1120 transmits a signal SGL, such as a command, an address, a control signal, and ID indicating a category of a file, to the SSD 1200 via the host interface 1121. The main memory of the host 1100 may be the DRAM 1130, however, example embodiments are not limited thereto.

The SSD 1200 receives and transmits the signal SGL from and to the host 1100 via the host interface 1211 and receives power through a power connector 1221. The SSD 1200 may include a plurality of nonvolatile memories 1201 to 120n, an SSD controller 1210, and an auxiliary power supply 1220. The nonvolatile memories 1201 to 120n may be implemented by using not only a NAND-flash memory but also a PRAM, an MRAM, a ReRAM, an FRAM, and the like.

The nonvolatile memories 1201 to 120n are used as storage medium of the SSD 1200. The nonvolatile memories 1201 to 120n may be connected to the SSD controller 1210 via a plurality of channels CH1 to CHn. One or more nonvolatile memories 1201 to 120n may be connected to a single channel. Nonvolatile memories 1201 to 120n connected to a single channel may be connected to the same data bus.

The SSD controller 1210 receives and transmits the signal SGL from and to the host 1100 via the host interface 1211. The signal SGL may include a command, an address, data or the like. The signal SGL may include an ID indicating a category of a write-requested file.

The SSD controller 1210 writes data into a nonvolatile memory 1201 to 120n or reads data from the nonvolatile memory 1201 to 120n according to a command of the host 1100. The SSD controller 1210 may process data by using a RAID system in the nonvolatile memories 1201 to 120n. In particular, the SSD controller 1210 may process data by using a RAID level-5 system in the nonvolatile memories 1201 to 120n.

The auxiliary power supply 1220 is connected to the host 1100 through the power connector 1221. The auxiliary power supply 1220 receives power PWR from the host 1100 to be charged. The auxiliary power supply 1220 may be disposed inside or outside the SSD 1200. For example, the auxiliary power supply 1220 may be disposed on a main board and supply auxiliary power to the SSD 1200.

The SSD system 1000 may divide the data inputted from the host 1100 into a plurality of data blocks and perform a deduplication operation on each of the data blocks. For example, the SSD system 1000 may perform the deduplication operation illustrated in FIG. 9.

The SSD controller 1210 of the SSD system 1000 generates parity data with reference to only data determined to be non-duplicated data in a stripe. Therefore, the number of write operations for the parity data is reduced and restoration probability of the SSD system 1000 increases when a data storage is damaged.

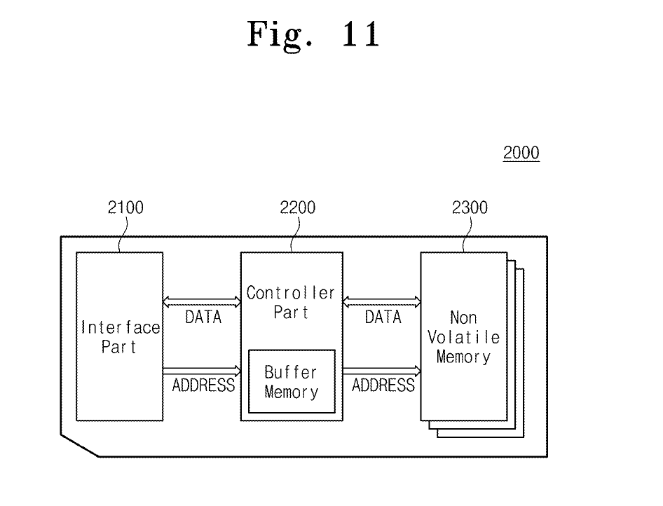

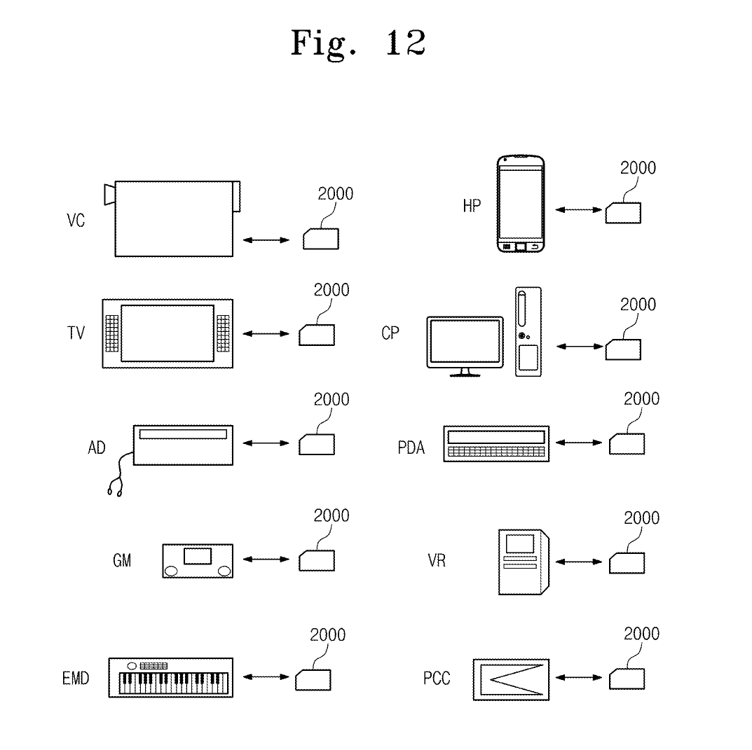

FIG. 11 is a block diagram illustrating an example in which a nonvolatile memory device according to some example embodiments is applied to a memory card 2000. The memory card 2000 may be an MMC, an SD card, a multiuse card, a micro SD card, a memory stick, a compact SD card, an ID card, a PCMCIA card, an SSD card, a chip card, a smart card, a USB card or the like.

Referring to FIG. 11, the memory card 2000 may include an interface part 2100 for interfacing with an external device, a controller part 2200 including a buffer memory and controlling an operation of the memory card 2000, and a plurality of flash memories 2300. The controller part 2200 may serve as a processor to control write and read operations of the flash memories 2300. The controller part 2200 may be coupled with the nonvolatile memories 2300 and the interface part 2100 via a data bus DATA and an address bus ADDRESS.

The controller part 2200 may divide data provided from the interface part 2100 into fixed-sized data units by using a RAID level-5 system. The controller part 2200 may dispersively store the divided data units in the nonvolatile memories 2300 constituting a logical storage according to a Round-Robin algorithm.

The memory card 2000 may divide data inputted from an external device into a plurality of data blocks and perform a deduplication operation on each of the data blocks. The controller part 2200 of the memory card 2000 generates parity data with reference to only data determined to be non-duplicated data in a stripe. Therefore, the number of write operations for the parity data is reduced and restoration probability of the memory card 2000 increases when a data storage is damaged.

FIG. 12 is an example diagram illustrating various systems to which the memory card 2000 in FIG. 11 is applied.

As illustrated in FIG. 12, the memory card 2000 may be applied to a video camera (VC), a television (TV), an audio device (AD), a game machine (GM), an electronic music device (EMD), a cellular phone (HP), a computer (CP), a personal digital assistant (PDA), a voice recorder (VR), a PC card (PCC), and the like.

A nonvolatile memory device may be packaged by using various types of packages. For example, a nonvolatile memory device according to some example embodiments may be packaged by one of PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

According to example embodiments, a deduplication operation is performed before generating parity data to assure reliability of data. Thus, the number of write operations is reduced and high restoration probability is exhibited.

While example embodiments have been particularly shown and described with reference to some example embodiments thereof, it will be understood by those of ordinary skill in the art that various changes in form and details may be made therein without departing from the spirit and scope of the example embodiments as defined by the following claims. For example, it is possible to adjust the driving capability of a sub word line driver or adjust the slope of level of applied driving signals by changing, adding, or removing the circuit configuration or arrangement in the drawings without departing from the technical spirit of the example embodiments.

What is claimed is:

1. A nonvolatile memory device configured to receive data from a host, the nonvolatile memory device comprising:
a plurality of data storage devices configured to store the received data in units of data storage units; and
a storage controller configured to control the plurality of data storage devices by storing, in at least one of the data storage devices, a first non-duplicated data storage unit from among the data storage units and first parity data generated with reference to the first non-duplicated data storage unit.

2. The nonvolatile memory device as set forth in claim 1, wherein the storage controller is further configured to determine which of the data storage units are duplicated before generating the first parity data.

3. The nonvolatile memory device as set forth in claim 2, wherein the storage controller is configured to determine whether the data storage units are duplicated using a hash value calculated for the data storage units.

4. The nonvolatile memory device as set forth in claim 1, wherein the storage controller is further configured to,
select ones of the data storage units, and
control the plurality of data storage devices such that a second non-duplicated data storage unit from among the selected data storage units and second parity data generated with reference to the second non-duplicated data storage unit are stored in the plurality of data storage devices.

5. The nonvolatile memory device as set forth in claim 1, wherein the storage controller is further configured to arrange the plurality of data storage devices as a redundant array of inexpensive disk (RAID) system.

6. A nonvolatile memory device configured to receive write-requested data from a host, the nonvolatile memory device comprising:
a plurality of data storage devices configured to store data in units of data blocks; and
a storage controller configured to,
divide the write-requested data to the unit of data blocks to generate a plurality of data blocks,
identify data blocks selected from among the plurality of data blocks that are duplicated,
generate parity data with reference to non-duplicated data blocks from among the selected data blocks, the non-duplicated data blocks being ones of the plurality of data blocks that are not identified as being duplicated, and
control the plurality of data storage devices such that the parity data and the non-duplicated data blocks are written into at least one of the plurality of data storage devices.

7. The nonvolatile memory device as set forth in claim 6, wherein the storage controller is further configured not to generate the parity data when all of the selected data blocks are duplicated.

8. The nonvolatile memory device as set forth in claim 6, wherein the storage controller is further configured to map a logical block address for duplicated data blocks from among the selected data blocks with a physical block address for a previously written data block having same data as the duplicated data blocks.

9. The nonvolatile memory device as set forth in claim 6, wherein the storage controller comprises:
a fingerprint generator configured to calculate a hash value associated with the data blocks; and
a deduplication table configured to store a hash value and a physical block address of each data block stored in the plurality of data storage devices, wherein
the storage controller is configured to identify a data block from among the selected data blocks as a duplicated data block, if the data block has a same hash value as the hash value stored in the deduplication table.

10. The nonvolatile memory device as set forth in claim 9, wherein the storage controller further comprises:
a main memory configured to have a deduplication manager and the deduplication table loaded therein; and
a processor configured to,
control the main memory such that the deduplication manager divides the write-requested data into the units of data blocks to generate the plurality of data blocks, and
identify the data blocks selected from among the plurality of data blocks that are duplicated.

11. The nonvolatile memory device as set forth in claim 10, wherein the processor is configured to load a parity generator to the main memory, and
wherein the processor is further configured to control the main memory such that the parity generator generates the parity data with reference to the non-duplicated data blocks from among the selected data blocks.

12. The nonvolatile memory device as set forth in claim 10, wherein
the storage controller is configured to allocate a memory capacity to the deduplication table, and
the deduplication manager is configured to replace an entry stored in the deduplication table when a capacity for the deduplication table exceeds the allocated memory capacity.

13. The nonvolatile memory device as set forth in claim 12, wherein the deduplication manager is configured to replace the entry stored in the deduplication table using a first-in-first-out (FIFO) algorithm.

14. A distributive disk controller, comprising:
a processor configured to,
associate write data received from a host with different storage devices such that the write data is distributed among the storage devices in units of data blocks;
identify if the data blocks of the write data are duplicative of a data block of stored data stored in the storage devices; and
for each data block identified as non-duplicative write data with respect to the stored data,
generate parity data associated with the non-duplicative write data based on the non-duplicative write data, and
store the non-duplicative write data and the parity data in the storage devices such that the non-duplicative write data is stored based on the association.

15. The distributive disk controller of claim 14, wherein if the write data is duplicative write data with respect to the stored data, the processor is configured to map a logical block address associated with the duplicative write data with a physical block address associated with the stored data which is duplicative thereof.

16. The distributive disk controller of claim 14, wherein the processor is configured to identify if the write data is duplicative of the stored data before generating the parity data associated therewith, and
for each and every one of the data blocks identified as duplicative of the stored data, the processor is configured not to generate corresponding parity data.

17. The distributive disk controller of claim 14, wherein the processor is configured to,
distribute the write data in the units of data blocks among the storage devices based on a redundant array of inexpensive disk (RAID)-5 distribution scheme, and
generate the parity data by performing an Exclusive OR (XOR) operation on the non-duplicative write data.

18. The distributive disk controller of claim 14, wherein the processor is configured not to generate parity data associated with a stripe, if the processor identifies all of the write data associated with the stripe as duplicative write data, the stripe being a set of the write data that is distributed by the distributive disk controller among the storage devices.

19. The distributive disk controller of claim 14, wherein the processor is configured to identify if the write data is duplicative of the stored data by,
calculating a hash value associated with the data blocks, and
identifying one of the data blocks of the write data as duplicative, if the hash value associated with the one of the data blocks is same as a hash value associated with a data block of the stored data.

20. The distributive disk controller of claim 14, wherein the distributive disk controller is a Redundant Array of Independent Disk (RAID) controller.
